(19) United States
(12) Patent Application Publication
(10) Pub. No.: US 2026/0267694 A1
(43) Pub. Date: Sep. 10, 2026

(54) BMC-BASED MEMORY RESOURCE PROCESSING DEVICE, METHOD AND APPARATUS, AND NON-TRANSITORY READABLE STORAGE MEDIUM

(71) Applicant: IEIT SYSTEMS CO., LTD., Jinan, Shandong (CN)

(72) Inventor: Xiaoyu MA, Jinan, Shandong (CN)

(73) Assignee: IEIT SYSTEMS CO., LTD., Jinan, Shandong (CN)

(21) Appl. No.: 18/873,662

(22) PCT Filed: Jul. 10, 2023
(86) PCT No.: PCT/CN2023/106630

§ 371 Date: Dec. 10, 2024

(30) Foreign Application Priority Data
Dec. 30, 2022 (CN) 202211713523.1

(51) Int. Cl. G06F 9/50; G06F 13/42

(52) U.S. Cl. CPC G06F 9/5016; G06F 13/4282; G06F 2213/0016

(57) ABSTRACT

Disclosed in the present disclosure are a Baseboard Management Controller (BMC)-based memory resource processing device, method and apparatus, and a non-transitory readable storage medium, which are applied to the technical field of computer resource allocation. Each memory bank is correspondingly connected to each Memory Expander Controller (MXC) and a BMC is connected to each MXC and is connected to a Central Processing Unit (CPU); and at least one MXC is connected to the CPU.

### CROSS-REFERENCE TO RELATED APPLICATIONS

The present application is a National Stage Application of PCT International Application No. PCT/CN 2023/106630 filed on Jul. 10, 2023, which claims priority to Chinese Patent Application 202211713523.1, filed in the China National Intellectual Property Administration on Dec. 30, 2022, the disclosure of which is incorporated herein by reference in its entirety.

### TECHNICAL FIELD

The present disclosure relates to the technical field of computer resource allocation, and in particular to a Baseboard Management Controller (BMC)-based memory resource processing device, method and apparatus, and a non-transitory readable storage medium.

### BACKGROUND

Scenarios such as Artificial Intelligence (AI) and machine learning, high-performance computing, and cloud and edge computing environments are complex and diverse. In order to meet resource demands, optimization and reconstruction need to be performed based on a server hardware architecture to improve the resource utilization rate and reduce the maintenance costs.

A Central Processing Unit (CPU) computing resource pool and a memory pool in an existing server resource pool are stored together, and the memory and Input/Output (I/O) expansion capabilities thereof lag far behind the growth of computing density, hindering the rapid development of heterogeneous computing. At the same time, for a server memory resource pool, the use of memory resources depends on a hard-wired Compute Express Link (CXL) bus. Since a memory not connected to the CXL bus is connected to Memory Expansion Controller (MXC) firmware, startup processing is performed in a unified manner, and although the memory not connected to the CXL bus is not actually used, the unified startup processing leads to a certain degree of resource waste.

Therefore, it is urgent for those skilled in the art to find a method for scheduling memory resources.

### SUMMARY

Embodiments of the present disclosure provide a BMC-based memory resource processing device, including a BMC, memory banks, a CPU, and MXC.

Each memory bank is correspondingly connected to each MXC, and the BMC is connected to each MXC and is connected to the CPU. At least one MXC is connected to the CPU.

The BMC is configured to acquire, after controlling a memory resource pool where each memory bank is located and a computing resource pool where the CPU is located power-on until Basic Input Output System (BIOS) has been initialized, target server identification information in the computing resource pool connected to the CPU, determine that the memory bank which corresponds to the MXC connected to the CPU is a target memory bank according to the target server identification information, and perform a power-on operation on the target memory bank to complete memory resource processing of the BMC.

In some embodiments of the present disclosure, the BMC includes a first BMC and a second BMC.

The first BMC is connected to each MXC, and the second BMC is connected to the CPU. In some embodiments of the present disclosure, the first BMC is connected to each MXC through an Inter-Integrated Circuit (I2C) bus.

In some embodiments of the present disclosure, each memory bank is correspondingly connected to each MXC through a CXL bus.

In some embodiments of the present disclosure, at least one MXC is connected to a Corrector Dinamico de Factor de Potencia (CDFP) interface of the CPU through a CDFP interface of the MXC corresponding to the memory bank.

In some embodiments of the present disclosure, the BMC-based memory resource processing device further includes a network switch.

The first BMC is connected to the network switch, and the network switch is connected to the second BMC.

In some embodiments of the present disclosure, the BMC-based memory resource processing device further includes a Peripheral Component Interconnect Express (PCIE) device connected to the CPU through the CXL bus.

In some embodiments of the present disclosure, a Retimer device is arranged at the PCIE device.

The Retimer device is connected to the CDFP interface of the CPU and is configured to realize the same clock source for the CPU and the memory bank.

In some embodiments of the present disclosure, the BMC-based memory resource processing device further includes an expander located at the Retimer device.

The expander is connected to the CDFP interface of the CPU, and the CDFP interface of the CPU is connected to a CDFP interface of the memory bank through the I2C bus.

The expander is configured to acquire server identification information in the computing resource pool at the CPU.

Embodiments of the present disclosure further provides a BMC-based memory resource processing method, which is applied to a BMC-based memory resource processing device, the device including a BMC, memory banks, a CPU, and MXC. Each memory bank is correspondingly connected to each MXC, and the BMC is connected to each MXC and is connected to the CPU. At least one MXC is connected to the CPU. The method includes the following operations.

After controlling a memory resource pool where each memory bank is located and a computing resource pool where the CPU is located power-on until BIOS has been initialized, target server identification information in the computing resource pool connected to the CPU is acquired.

It is determined that the memory bank which corresponds to the MXC connected to the CPU is a target memory bank according to the target server identification information.

A power-on operation is performed on the target memory bank to complete memory resource processing of the BMC.

In some embodiments of the present disclosure, before the target server identification information in the computing resource pool connected to the CPU is acquired, the method further includes the following operations.

A connection state between the BMC and the CPU is acquired.

When the connection state is a normal connection, the server identification information in the computing resource pool is determined.

In some embodiments of the present disclosure, the operation of acquiring the target server identification information in the computing resource pool connected to the CPU includes the following operations.

The server identification information is acquired.

The server identification information is compared with identification information in a pre-stored identification information table to determine the target server identification information.

In some embodiments of the present disclosure, the operation of performing the power-on operation on the target memory bank includes the following operations.

Instruction information of the BMC is acquired.

The instruction information is sent to each MXC, so that each MXC determines a power-on state of the memory bank to which each MXC belongs.

When it is determined that the memory bank to which each MXC belongs is the target memory bank, power-on processing is performed on the target memory bank.

In some embodiments of the present disclosure, the instruction information of the BMC includes at least memory asset information, temperature information, voltage information, and power consumption information.

In some embodiments of the present disclosure, the server identification information includes at least server Identity Document (ID) information.

In some embodiments of the present disclosure, the method further includes the following operation.

If other memory banks except the target memory bank are not connected to the CPU, power-on processing is not performed on the other memory banks.

In some embodiments of the present disclosure, the method further includes the following operation.

After the target server identification information is acquired, resource allocation processing is performed on the computing resource pool of the CPU.

Embodiments of the present disclosure further provides a BMC-based memory resource processing apparatus, which is applied to a BMC-based memory resource processing device, the device including a BMC, memory banks, a CPU, and MXC. Each memory bank is correspondingly connected to each MXC, and the BMC is connected to each MXC and is connected to the CPU. At least one MXC is connected to the CPU. The apparatus includes an acquisition component, a determination component, and a power-on component.

The acquisition component is configured to acquire, after controlling a memory resource pool where each memory bank is located and a computing resource pool where the CPU is located power-on until BIOS has been initialized, target server identification information in the computing resource pool connected to the CPU.

The determination component is configured to determine that the memory bank which corresponds to the MXC connected to the CPU is a target memory bank according to the target server identification information.

The power-on component is configured to perform a power-on operation on the target memory bank to complete memory resource processing of the BMC.

Embodiments of the present disclosure further provide a BMC-based memory resource processing apparatus, including a memory and a processor.

The memory is configured to store a computer program.

The processor is configured to implement the steps of the above BMC-based memory resource processing method when executing the computer program.

Embodiments of the present disclosure further provides a non-transitory computer readable storage medium, on which a computer program is stored. When executed by a processor, the computer program implements the steps of the above BMC-based memory resource processing method.

### BRIEF DESCRIPTION OF THE DRAWINGS

In order to more clearly illustrate the embodiments of the present disclosure, the drawings used in the embodiments will be briefly described below. It is apparent that the drawings described below are only some embodiments of the present disclosure. Other drawings may further be obtained by those of ordinary skill in the art according to these drawings without creative efforts.

FIG. 1 is a structural diagram of a BMC-based memory resource processing device provided by some embodiments of the present disclosure.

FIG. 2 is a flowchart of a BMC-based memory resource processing method provided by some embodiments of the present disclosure.

FIG. 3 is a structural diagram of a BMC-based memory resource processing apparatus provided by some embodiments of the present disclosure.

FIG. 4 is a structural diagram of another BMC-based memory resource processing apparatus provided by some embodiments of the present disclosure.

FIG. 5 is a structural diagram of another BMC-based memory resource processing device provided by some embodiments of the present disclosure.

### DETAILED DESCRIPTION OF THE EMBODIMENTS

The technical solutions in embodiments of the present disclosure will be clearly and completely described below in conjunction with the drawings in the embodiments of the present disclosure. It is apparent that the described embodiments are only part of the embodiments of the present disclosure but not all the embodiments. All other embodiments obtained by those of ordinary skill in the art on the basis of the embodiments in the disclosure without creative work shall fall within the scope of protection of the disclosure.

The core of the present disclosure is to provide a BMC-based memory resource processing device, method and apparatus, and a non-transitory readable storage medium, so as to prevent the resource consumption of an existing memory when a corresponding MXC and CPU are not connected after unified startup processing, thereby reducing the power consumption resource waste of resource pooling.

In order to make the solutions of the present disclosure understood by those skilled in the art, the present disclosure will be described below in detail in combination with the drawings and the optional implementations.

It is to be noted that server resource pooling mainly includes a CPU computing resource pool, a memory pool, a storage pool, and an I/O pool. This reconstruction of hardware resources may realize dynamic allocation of resources, improve the utilization rate of server hardware resources, and reduce the operation and maintenance costs of a single server.

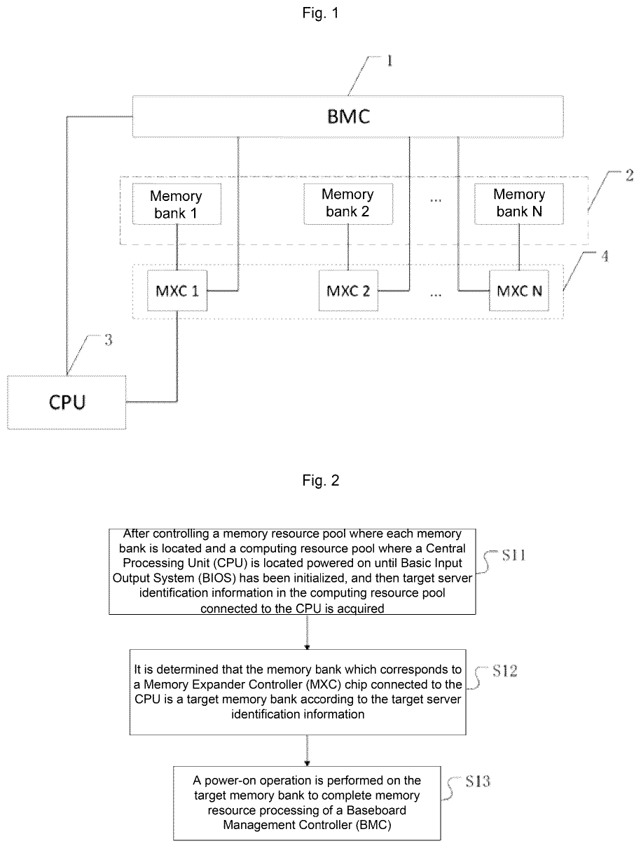

FIG. 1 is a structural diagram of a BMC-based memory resource processing device provided by some embodiments of the present disclosure. As shown in FIG. 1, the device includes a BMC 1, memory banks 2, a CPU 3, and MXC 4.

Each memory bank 2 is correspondingly connected to each MXC 4, and the BMC 1 is connected to each MXC 4 and is connected to the CPU 3. At least one MXC is connected to the CPU 3.

The BMC 1 is configured to acquire, after controlling a memory resource pool where each memory bank 2 is located and a computing resource pool where the CPU 3 is located power-on until BIOS has been initialized, target server identification information in the computing resource pool connected to the CPU 3, determine that the memory bank which corresponds to the MXC connected to the CPU 3 is a target memory bank according to the target server identification information, and perform a power-on operation on the target memory bank to complete memory resource processing of the BMC. The expression “BIOS has been initialized” means that an initialization process of the BIOS has been started, or has been finished.

In some embodiments of the present disclosure, a BMC is a small operating system independent of a server system and is integrated on a mainboard, and some products are also plugged into the mainboard in a form such as PCIE and externally act as a standard Registered Jack 45 (RJ45) network port and a firmware system with an independent Internet Protocol (IP) address. A server cluster generally uses BMC instructions for large-scale unattended operations, including remote management, monitoring, installation, and restart of servers. The MXC is a CXL Dynamic Random Access Memory (DRAM) memory controller, which belongs to the third device type defined by a CXL protocol. The MXC supports JEDEC DDR4 (a memory standard) and Double Data Rate 5 (DDR 5) standards, and also complies with the CXL 2.0 specification, and supports a rate of Peripheral Component Interconnect Express 5.0 (PCIe 5.0). The MXC may provide a high-bandwidth and low-latency high-speed interconnect solution for the CPU and a CXL-based device, thereby realizing memory sharing between the CPU and each CXL device, significantly improving system performance while significantly reducing the complexity of a software stack and Total Cost of Ownership (TCO) of a data center.

The MXC realizes information monitoring and power-on and power-off management of a memory in the memory resource pool, and transfers memory resources to the CPU computing resource pool to establish a connection, so that the computing resource pool uses the memory resources.

Each memory bank is correspondingly connected to each MXC, that is, one memory bank corresponds to one MXC, where the BMC is connected to each MXC, and the BMC is further connected to the CPU. In order for the CPU computing resource pool to use the resources of the memory pool, the CPU needs to be connected to the MXC. It is understandable that not all MXC are connected to the CPU, depending on the actual situation. Since the MXC is connected to the memory bank, in a case where the CPU uses a certain memory bank, the MXC connected to the corresponding memory bank is connected to the CPU, that is, at least one MXC is connected to the CPU.

The BMC is configured to acquire target server identification information in the computing resource pool connected to the CPU, so as to determine that the memory bank of the MXC connected to the CPU is a target memory bank according to the target server identification information, and perform a power-on operation on the target memory bank. It is to be noted that the prerequisite for acquiring the target server identification information is that the BMC controls the memory resource pool and the computing resource pool power-on until BIOS has been initialized, that is, a memory power-on operation is performed after an Advanced Configuration and Power Interface (ACPI) S3 state in a memory training phase. After the memory power-on operation is completed, the power-on startup of the computing resource pool is continued to be completed. At this time, after the process is completed, normal functions of the server may be used.

The BMC-based memory resource processing device provided by the embodiment of the present disclosure includes the BMC, the memory banks, the CPU, and the MXC. Each memory bank is correspondingly connected to each MXC, and the BMC is connected to each MXC and is connected to the CPU. At least one MXC is connected to the CPU. The BMC is configured to acquire, after controlling the memory resource pool where each memory bank is located and the computing resource pool where the CPU is located power-on until BIOS has been initialized, the target server identification information in the computing resource pool connected to the CPU, determine that the memory bank which corresponds to the MXC connected to the CPU is the target memory bank according to the target server identification information, and perform the power-on operation on the target memory bank to complete memory resource processing of the BMC. According to the device, the CPU computing resource pool at the CPU is separated from the memory pool at the memory bank, so that memory disaggregation is realized, thereby solving the existing problems of a memory bandwidth being insufficient and capacity demands being great. Before startup processing, it is determined by means of target service identification information that a memory resource is allocated to a computer resource pool, and installation processing is performed only on the memory bank which corresponds to the MXC connected to the CPU and to which the target service identification information belongs, thereby preventing the resource consumption of an existing memory when the corresponding MXC and CPU are not connected after unified startup processing, and the power consumption resource waste of resource pooling is thus reduced.

Based on the above embodiment, since the memory bank is separated from the memory pool of the CPU, in some embodiments, the BMC includes a first BMC and a second BMC.

The first BMC is connected to each MXC, and the second BMC is connected to the CPU.

In some embodiments of the present disclosure, the first BMC is connected to each MXC and is configured to control the allocation and use of the memory resource pool. The second BMC is connected to the CPU and is configured to control the computing resource pool.

In general, the second BMC in the computing resource pool needs to provide an out-of-band management Redfish interface for power-on control of the computing resource pool, and after the first BMC in the memory resource pool jointly controls a plurality of computing resource pools from power-on to the ACPI S3 state, the memory power-on operation is performed.

Based on the above embodiment, in some embodiments, the first BMC is connected to each MXC through an I2C (parallel bus).

The parallel bus is mainly configured for short-distance and low-speed communication between the devices. The I2C bus has two bidirectional signal lines: a data line, i.e., a Serial Data Line (SDA), configured to send and receive data, and a clock line, i.e., a Serial Clock Line (SCL), configured to synchronize clocks of both communication parties. The I2C bus has a simple hardware structure, simplifies wiring of a Printed Circuit Board (PCB), reduces system costs, improves system reliability, and therefore is widely used in various fields.

The I2C bus is a multi-host bus. Devices connected to the I2C bus are classified into hosts and slaves. The host has the right to initiate and end a communication, and the slave may only make a passive call. When a plurality of hosts on the bus enable the bus at the same time, I2C also has the functions of conflict detection and arbitration to prevent errors. Each device connected to the I2C bus has a unique address (7bit (byte)), and each device may be used as the host or the slave (but there may only be one host at a time). The addition and deletion of the devices on the bus do not affect the normal operation of other devices. When the I2C bus is in communication, the device that sends data on the bus is a transmitter, and the device that receives data is a receiver. The I2C bus may be detected online through external connections, which is convenient for system fault diagnosis and debugging. Faults may be addressed immediately, and software is also conducive to standardization and modularization, thereby shortening the development time.

Based on the above embodiment, the device further includes a network switch.

The first BMC is connected to the network switch, and the network switch is connected to the second BMC.

It is understandable that the network switch is connected to the first BMC and the second BMC to realize the network interconnection between the first BMC and the second BMC. For the network switch, the first BMC and the second BMC thereof are connected to the network switch through a dedicated management port network to realize network interconnection.

The connection mode and corresponding functions of the first BMC and the second BMC provided by the embodiment of the present disclosure realize the control resources of the CPU computing resource pool and the memory resource pool and the corresponding network interconnection.

Based on the above embodiment, each memory bank is correspondingly connected to each MXC through a CXL bus.

It is understandable that a CXL protocol is an industry-supported cache coherent interconnect protocol for processors, memory extensions, and accelerators. CXL technology maintains coherence between a CPU memory space and a memory on an attached device, which allows resource sharing for higher performance, reduces the complexity of the software stack, and reduces overall system costs, so that a user simply focuses on the target workload rather than the redundant memory management hardware in the accelerator.

Compared with version 1.1, the CXL 2.0 specification adds support for fan-out switching to connect to more devices, memory pools for improving the memory utilization efficiency and providing the memory capacity on demand, and support for persistent memory. The CXL bus provided by the embodiment may be version 1.1 or version 2.0, which is not limited herein and may be set according to the actual situation.

In addition, the MXC and the CPU may be connected through the interface or in other manners, which is not limited herein. In some embodiments, at least one MXC is connected to a CDFP interface of the CPU through a CDFP interface of the MXC corresponding to the memory bank.

It is understandable that the CDFP interface may reach a data rate of 25 Gigabits per second (Gbps) per channel on 16 channels, thereby achieving a total data transmission speed of 400 Gbps. Current and next-generation Ethernet and PCIe network protocols are supported. These CDFP I/O connectors realize 16 channels of bidirectional data communication in one port, with the highest number of channels per port on the market. The CDFP I/O connectors provide custom wiring options and support direct copper interfaces and active optical interfaces. Typical applications include routers, high-performance computing, storage, controller cards, servers, Network Interface Cards (NICs), and Graphics Processing Units (GPUs).

The CDFP interface of the MXC is connected to the CDFP interface of the CPU, which means that the memory bank currently connected to the MXC is indirectly connected to the CDFP interface of the CPU.

In a case where the MXC is connected to the CPU, the CDFP interface is used, that is, the CDFP interface is provided at each end. A connection bus between the two interfaces is not limited herein, and may be an I2C bus, a CXL bus, or other buses. The description of the I2C bus and the CXL bus is not repeated here, and reference may be made to the above embodiment.

In the embodiments of the present disclosure, at least one MXC is connected to the CDFP interface of the CPU through the CDFP interface of the MXC corresponding to the memory bank, thereby realizing the connection between the memory and the CPU resources.

Based on the above embodiment, the device further includes a PCIE device connected to the CPU through a CXL bus.

It is understandable that the PCIE device is connected to the CDFP interface of the CPU and is also connected to the CPU through the CXL bus so as to be configured to realize the connection between the memory resource pool and the CPU computing resource pool.

A Retimer (re-driver) device is provided at the PCIE device. In some embodiments, the Retimer device is connected to the CDFP interface of the CPU and is configured to realize the same clock source for the CPU and the memory bank.

The Retimer device is located at the PCIE device and is configured to enhance a clock signal to realize the same clock source for the CPU and the memory bank. The ReTimer may achieve a better effect of reducing the physical loss of the channel than a ReDriver (signal redriver). The Retimer device is also a retimer, i.e., a simple command line timer for a Macintosh Operating System (MacOS) using a reminder application, and uses an apple script (AppleScript scripting language) to create a reminder in the reminder application. In this way, notifications may be easily received on all devices without installing third-party applications or running additional background processes. Functions of the Retimer device include: 1, notification after countdown (for example, 2 days, 5 hours and 2 minutes); 2, notification at a specific time (for example, 10: 30); 3, notification of a regular event (for example, 5 times every 20 minutes); and 4, notification of a Promodoro (Pomodoro Technique) timer (for example, usually 5 times in 20 minutes, with a 5-minute interval between blocks).

In some embodiments, the device includes an expander located at the Retimer device.

The expander is connected to the CDFP interface of the CPU, and the CDFP interface of the CPU is connected to a CDFP interface of the memory bank through the I2C bus.

The expander is configured to acquire server identification information in the computing resource pool at the CPU.

In some embodiments of the present disclosure, the model of the expander may be PCA9554, which is connected to the CDFP interface of the CPU and is configured to acquire the server identification information in the computing resource pool of the CPU, such as a sever ID.

The Retimer device provided by the embodiment is connected to the CDFP interface of the CPU and is configured to realize the same clock source for the CPU and the memory bank, and the expander is connected to the CDFP interface of the CPU and is configured to acquire the server identification information in the computing resource pool at the CPU.

FIG. 2 is a flowchart of a BMC-based memory resource processing method provided by some embodiments of the present disclosure. The method is applied to a BMC-based memory resource processing device. The device includes a BMC, memory banks, a CPU, and MXC. Each memory bank is correspondingly connected to each MXC, and the BMC is connected to each MXC and is connected to the CPU. At least one MXC is connected to the CPU. As shown in FIG. 2, the method includes the following operations.

At S11, After controlling a memory resource pool where each memory bank is located and a computing resource pool where the CPU is located power-on until BIOS has been initialized, target server identification information in the computing resource pool connected to the CPU is acquired.

At S12, it is determined that the memory bank which corresponds to the MXC connected to the CPU is a target memory bank according to the target server identification information.

At S13, a power-on operation is performed on the target memory bank to complete memory resource processing of the BMC.

It is understandable that after the BMC controls the memory resource pool where each memory bank is located and the computing resource pool where the CPU is located power-on until BIOS has been initialized, that is, after the memory resource pool and a plurality of computing resource pools are powered on to an ACPI S3 state together, a memory operation begins, which is the problem of the memory power-on operation solved in the embodiment. The acquisition of the target server identification information of the computing resource pool connected to the CPU corresponds to the acquisition of the target server identification information before the corresponding memory power-on operation, so as to determine the memory allocated to the computing resource pool.

The memory allocated to the computing resource pool is determined to determine the target memory bank through the target server identification information, then the power-on operation is performed on the memory (target memory bank) allocated to the computing resource pool, and power-on processing is not performed on the memory (non-target memory bank) unallocated to the computing resource pool. How to determine the memory unallocated to the computing resource pool is that the memory bank corresponding to the corresponding connected MXC may be determined by connecting the MXC to the CPU. That is, if the MXC is connected to the CPU, the corresponding memory bank is the target memory bank, and if the MXC is not connected to the CPU, the corresponding memory bank is the non-target memory bank.

The BMC-based memory resource processing method provided by the present disclosure includes that: after controlling the memory resource pool where each memory bank is located and the computing resource pool where the CPU is located power-on until BIOS has been initialized, the target server identification information in the computing resource pool connected to the CPU is acquired, it is determined that the memory bank which corresponds to the MXC connected to the CPU is the target memory bank according to the target server identification information, and the power-on operation is performed on the target memory bank to complete memory resource processing of the BMC. According to the method, the CPU computing resource pool at the CPU is separated from the memory pool at the memory bank, so that memory disaggregation is realized, thereby solving the existing problems of a memory bandwidth being insufficient and capacity demands being great. Before startup processing, it is determined by means of target service identification information that a memory resource is allocated to a computer resource pool, and installation processing is performed only on the memory bank which corresponds to the MXC connected to the CPU and to which the target service identification information belongs, thereby preventing the resource consumption of an existing memory when the corresponding MXC and CPU are not connected after unified startup processing, and the power consumption resource waste of resource pooling is thus reduced.

Based on the above embodiment, before the target server identification information in the computing resource pool connected to the CPU is acquired in S11, the method further includes the following operations.

A connection state between the BMC and the CPU is acquired.

When the connection state is a normal connection, server identification information in the computing resource pool is determined.

In some embodiments of the present disclosure, it is determined whether the connection state between the BMC and the CPU is a normal connection, and in a case where the connection state between the BMC and the CPU is the normal connection, the corresponding server identification information of the computing resource pool is determined. The server identification information may be a server ID, or information such as an IP address, which is not limited herein. In some embodiments, the connection state of the corresponding interface may be acquired by an access state of PCA9554, and during startup, the state is acquired by the BMC of the memory resource pool, and the corresponding CDFP and the server ID of the computing resource pool are confirmed.

In some embodiments, the server identification information includes at least server ID information.

In some embodiments of the present disclosure, the server ID information, that is, the server ID, may further include identification IP address information, etc., which is not limited. The more the server identification information, the more accurate the subsequently determined target memory bank. Of course, considering the rapidity of power-on time, it is not the more the server identification information, the better, and it may be choose according to the actual situation.

After the server identification information is determined, the determination of the target server identification information is as one embodiment, and the operation of acquiring the target server identification information in the computing resource pool connected to the CPU in S11 includes the following operations.

The server identification information is acquired.

The server identification information is compared with identification information in a pre-stored identification information table to determine the target server identification information.

In some embodiments of the present disclosure, the server identification information is compared with the identification information pre-stored in the identification information table of the BMC to determine the target server identification information, that is, to check whether the current server identification information is legal. In some embodiments, the BMC acquires the corresponding server ID of the computing resource pool through a CDFP I2C to determine whether a legal ID is obtained. If it is legal, the target server identification information is determined.

According to the process of determining the target server identification information provided by the embodiment of the present disclosure, the accuracy of determination is improved, and by performing two determinations: a state of a connection interface is determined for the first time, and the second determination is made by comparing the identification information in the identification information table, the accuracy of the subsequent power-on operation is improved.

Based on the above embodiment, the operation of performing the power-on operation on the target memory bank includes the following operations.

Instruction information of the BMC is acquired.

The instruction information is sent to each MXC, so that each MXC determines a power-on state of the memory bank to which each MXC belongs.

When it is determined that the memory bank to which each MXC belongs is the target memory bank, power-on processing is performed on the target memory bank.

It is understandable that the instruction information of the BMC is acquired, the instruction information is sent to each MXC for interaction, it is notified whether the MXC needs to power on the memory to which the MXC belongs during startup, that is, the power-on state of the memory bank to which each MXC belongs is determined, and when it is determined that the memory bank to which each MXC belongs is the target memory bank, only the required memory bank is powered on separately, and the power-on operation is not performed on the memory bank not connected to the CDFP, so as to achieve the effect of saving power consumption.

Correspondingly, in some embodiments, the instruction information of the BMC includes at least memory asset information, temperature information, voltage information, and power consumption information.

In some embodiments of the present disclosure, the instruction information includes at least the memory asset information, the temperature information, the voltage information, and the power consumption information, including but not limited to current information, and may also be connection state information, etc. The memory asset information is the memory capacity information of the memory bank, the temperature information may be the temperature of the entire memory or the temperature information of each memory bank, and the power consumption information is the current power consumption of the memory.

Based on the above embodiment, the method further includes the following operation.

If other memory banks except the target memory bank are not connected to the CPU, power-on processing is not performed on the other memory banks.

The interactive control provided by the embodiment corresponds to the power-on operation of the subordinate memory, that is, only the required memory bank is powered on separately, and the power-on operation is not performed on the memory bank not connected to the CDFP, so as to achieve the effect of saving power consumption.

Based on the above embodiment, the method further includes the following operation.

After the target server identification information is acquired, resource allocation processing is performed on the computing resource pool of the CPU.

In some embodiments of the present disclosure, for the acquisition of the target server identification information, in the embodiment, the dynamic power-on management of the memory resources is realized according to the information, and power-on processing is not performed on the unused memory in the resource pool, thereby reducing the problem of power consumption resource waste when the memory resource pool is not fully connected to the computing resource pool. At the same time, specific processing may be performed on the target server identification information, and computing resources may be dynamically allocated according to the content of the information.

According to the embodiment of the present disclosure, after the BMC of the memory resource pool acquires the target server identification information, different power-on management solutions are adopted to perform specific processing on specific servers, thereby solving the problem of dynamic allocation of the memory resources.

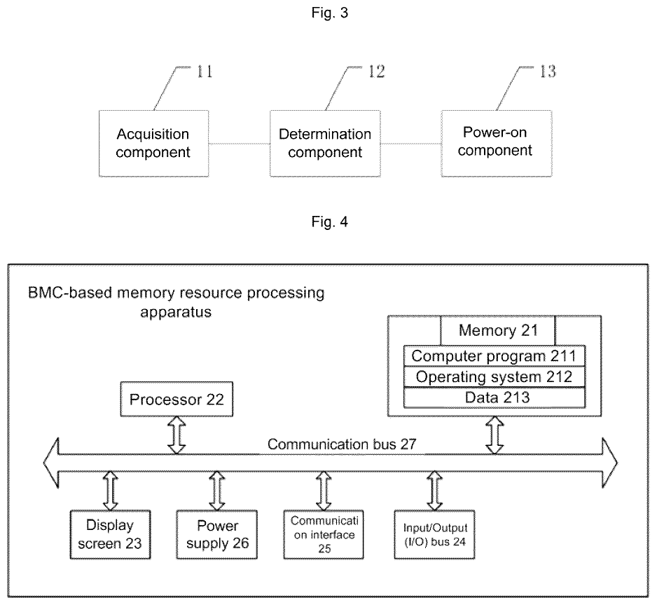

Various embodiments corresponding to the BMC-based memory resource processing method are described in detail above, and based on this, the present disclosure further discloses a BMC-based memory resource processing apparatus corresponding to the above method. FIG. 3 is a structural diagram of a BMC-based memory resource processing apparatus provided by some embodiments of the present disclosure. As shown in FIG. 3, the BMC-based memory resource processing apparatus is applied to a BMC-based memory resource processing device. The device includes a BMC, memory banks, a CPU, and MXC. Each memory bank is correspondingly connected to each MXC, and the BMC is connected to each MXC and is connected to the CPU. At least one MXC is connected to the CPU. The apparatus includes an acquisition component 11, a determination component 12, and a power-on component 13.

The acquisition component 11 is configured to acquire, after controlling a memory resource pool where each memory bank is located and a computing resource pool where the CPU is located power-on until BIOS has been initialized, target server identification information in the computing resource pool connected to the CPU.

The determination component 12 is configured to determine that the memory bank which corresponds to the MXC connected to the CPU is a target memory bank according to the target server identification information.

The power-on component 13 is configured to perform a power-on operation on the target memory bank to complete memory resource processing of the BMC.

Since the embodiment of the apparatus part and the above embodiment correspond to each other, the embodiment of the apparatus part and the description the embodiment of the method part may be referred to each other, which will not be elaborated herein.

The BMC-based memory resource processing apparatus provided by the present disclosure is described with reference to the above method embodiment, which will not be elaborated herein, and has the same beneficial effects as the above BMC-based memory resource processing method.

FIG. 4 is a structural diagram of another BMC-based memory resource processing apparatus provided by some embodiments of the present disclosure. As shown in FIG. 4, the apparatus includes a memory 21 and a processor 22.

The memory 21 is configured to store a computer program.

The processor 22 is configured to implement the steps of the above BMC-based memory resource processing method when executing the computer program.

The BMC-based memory resource processing apparatus provided by the embodiment may include, but is not limited to, a smart phone, a tablet computer, a notebook computer or a desktop computer.

The processor 22 may include one or more processing cores, such as a 4-core processor, an 8-core processor, etc. The processor 22 may be implemented in at least one hardware form of a Digital Signal Processor (DSP), a Field-Programmable Gate Array (FPGA), and a Programmable Logic Array (PLA). The processor 22 may also include a main processor and a coprocessor. The main processor is a processor configured to process data in a wake state, also known as a CPU, and the coprocessor is a low-power processor configured to process data in a standby state. In some embodiments, the processor 22 may be integrated with a GPU, which is responsible for rendering and drawing the content that a display screen needs to display. In some embodiments, the processor 22 may further include an AI processor, which is configured to process computational operations related to machine learning.

The memory 21 may include one or more computer non-transitory readable storage media, which may be non-transient. The memory 21 may further include a high speed Random Access Memory (RAM) and a non-transitory memory such as one or more magnetic storage apparatuses and a flash memory. In the embodiment, the memory 21 is configured to store at least the following computer program 211. The computer program, after being loaded and executed by processor 22, is capable of implementing the relevant steps of the BMC-based memory resource processing method disclosed in any of the foregoing embodiment. In addition, resources stored by the memory 21 may further include an operating system 212 and data 213, etc., and a storage method may be transient storage or permanent storage. The operating system 212 may include Windows, Unix, linux, etc. The data 213 may include, but is not limited to, data involved in the BMC-based memory resource processing method, etc.

In some embodiments, the BMC-based memory resource processing apparatus may further include a display screen 23, an I/O interface 24, a communication interface 25, a power supply 26, and a communication bus 27.

It may be understood by those skilled in the art that the structure shown in FIG. 4 does not constitute a limitation to the BMC-based memory resource processing apparatus, and may include more or fewer components than shown in the figure.

The processor 22 implements the BMC-based memory resource processing method provided by any of the above embodiments by calling instructions stored in the memory 21.

The BMC-based memory resource processing apparatus provided by the present disclosure is described with reference to the above method embodiment, which will not be elaborated herein, and has the same beneficial effects as the above BMC-based memory resource processing method.

Further, the present disclosure further provides a non-transitory computer readable storage medium, on which a computer program is stored. When executed by a processor, the computer program 22 implements the steps of the above BMC-based memory resource processing method.

It is understandable that, when being realized in form of software functional unit and sold or used as an independent product, the method in the above embodiment may be stored in the non-transitory computer readable storage medium. Based on this understanding, the technical solutions of the disclosure essentially or the parts that contribute to the conventional art, or all or part of the technical solutions may be embodied in the form of a software product. The computer software product is stored in the non-transitory readable storage medium to execute all or part of the steps of the method described in the various embodiments of the present disclosure. The above-mentioned non-transitory readable storage medium includes: various non-transitory readable storage media capable of storing program codes such as a U disk, a mobile hard disk, a Read-Only Memory (ROM), an RAM, a magnetic disk, or an optical disk.

The non-transitory computer readable storage medium provided by the present disclosure is described with reference to the above method embodiment, which will not be elaborated herein, and has the same beneficial effects as the above BMC-based memory resource processing method.

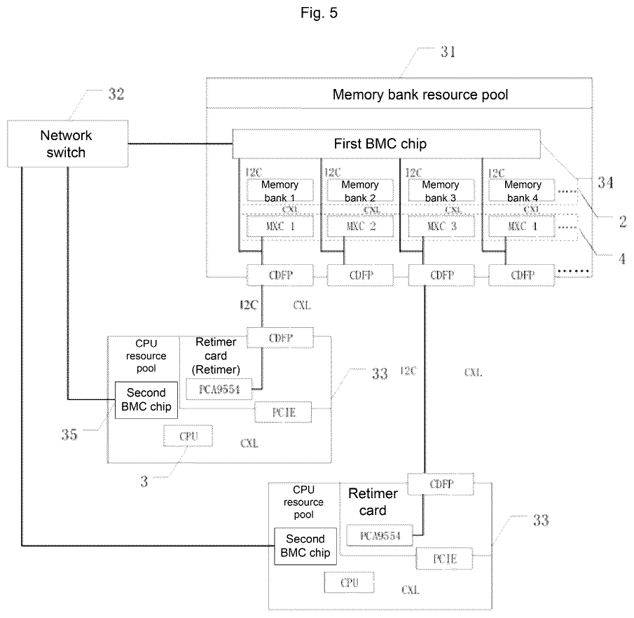

As one embodiment, FIG. 5 is a structural diagram of another BMC-based memory resource processing device provided by some embodiments of the present disclosure. As shown in FIG. 5, the following is included.

A first BMC 34 in FIG. 5 is a BMC located in a memory bank resource pool 31, a second BMC 35 is a BMC located in a CPU resource pool 33, a Retimer card is a Retimer device, and PCA9554 is an expander. Each memory bank 2 is correspondingly connected to each MXC 4, the first BMC 34 is connected to each MXC 4, and the second BMC 35 is connected to a CPU 3. At least one MXC 4 is connected to the CPU 3, that is, at least one MXC 4 is connected to a CDFP interface of the CPU 3 through a CDFP interface of the MXC 4 corresponding to the memory bank 2. The first BMC 34 is connected to a network switch 32, and the network switch 32 is connected to the second BMC 35. The first BMC 34 is connected to each MXC 4 through an I2C bus, and at least one MXC 4 is connected to the CDFP interface of the CPU 3 through the CDFP interface of the MXC 4 corresponding to the memory bank 2. The steps are as follows.
1. An MXC realizes information monitoring and power-on and power-off management of a memory in a memory resource pool, and transfers a CXL bus of the memory to the CDFP interface for a computing resource pool to connect and use memory resources.
2. A BMC is connected to the MXC through an I2C, and interacts with MXC firmware to acquire state information such as memory asset information, temperature, voltage, power consumption, etc., and interacts with the MXC firmware through an I2C command to control the power-on of the corresponding subordinate memory.
3. A CDFP is connected to the Retimer card in the CPU computing resource pool to enhance a clock signal and realize the same clock source, and then is connected to the CPU through CXL to realize a connection between the memory and CPU resources.
4. A BMC I2C is connected to an I2C part of the CDFP interface, and then is connected to PCA9554 on the Retimer card of the computing resource pool to acquire a server ID of the CPU computing resource pool.
5. BMC dedicated management port networks of the memory resource pool and the computing resource pool are connected to one network switch to realize network interconnection.

The BMC-based memory resource processing device provided by the present disclosure is described with reference to the above device embodiment, which will not be elaborated herein, and has the same beneficial effects as the above BMC-based memory resource processing device.

The BMC-based memory resource processing device, the BMC-based memory resource processing method and apparatus, and the non-transitory readable storage medium provided by the present disclosure are described in detail above. The various embodiments in the present specification are described in a progressive manner, and each embodiment focuses on differences from other embodiments, and the same similar parts between the various embodiments may be referred to each other. For the apparatus disclosed in the embodiment, since it corresponds to the method disclosed in the embodiment, the description is relatively simple, and the relevant parts may be referred to the method part. It is to be noted that a number of variations and modifications may be made by those of ordinary skill in the art without departing from the principle of the disclosure, and all fall within the scope of protection of the claims of the disclosure.

It is also to be noted that relational terms “first”, “second” and the like in the specification are adopted only to distinguish one entity or operation from another entity or operation and not always to require or imply existence of any such practical relationship or sequence between the entities or operations. Furthermore, terms “include” and “contain” or any other variant thereof is intended to cover nonexclusive inclusions herein, so that a process, method, object or device including a series of elements not only includes those elements but also includes other elements which are not clearly listed or further includes elements intrinsic to the process, the method, the object or the device. Under the condition of no more limitations, an element defined by the statement “including a/an . . . ” does not exclude existence of the same other elements in a process, method, object or device including the element.

1. A Baseboard Management Controller (BMC)-based memory resource processing device, comprising a BMC chip, memory banks, a Central Processing Unit (CPU), and Memory Expander Controller (MXC);
each memory bank is correspondingly connected to each MXC-chip, and the BMC is connected to each MXC and is connected to the CPU; at least one MXC is connected to the CPU; and
the BMC is configured to acquire, after controlling a memory resource pool where each memory bank is located and a computing resource pool where the CPU is located power-on until Basic Input Output System (BIOS) has been initialized, target server identification information in the computing resource pool connected to the CPU, determine that the memory bank which corresponds to the MXC connected to the CPU is a target memory bank according to the target server identification information, and perform a power-on operation on the target memory bank to complete memory resource processing of the BMC.

2. The BMC-based memory resource processing device as claimed in claim 1, wherein the BMC comprises a first BMC and a second BMC;
the first BMC is connected to each MXC, and the second BMC is connected to the CPU.

3. The BMC-based memory resource processing device as claimed in claim 2, wherein the first BMC is connected to each MXC through an Inter-Integrated Circuit (I2C) bus.

4. The BMC-based memory resource processing device as claimed in claim 1, wherein each memory bank is correspondingly connected to each MXC through a Compute Express Link (CXL) bus.

5. The BMC-based memory resource processing device as claimed in claim 1, wherein at least one MXC is connected to a Corrector Dinamico de Factor de Potencia (CDFP) interface of the CPU through a CDFP interface of the MXC corresponding to the memory bank.

6. The BMC-based memory resource processing device as claimed in claim 2, further comprising a network switch;
the first BMC is connected to the network switch, and the network switch is connected to the second BMC.

7. The BMC-based memory resource processing device as claimed in claim 1, further comprising a Peripheral Component Interconnect Express (PCIE) device connected to the CPU through a CXL bus.

8. The BMC-based memory resource processing device as claimed in claim 7, wherein a redrive Retimer device is arranged at the PCIE device; and
the Retimer device is connected to a CDFP interface of the CPU and is configured to realize the same clock source for the CPU and the memory bank.

9. The BMC-based memory resource processing device as claimed in claim 8, further comprising an expander located at the Retimer device;
the expander is connected to the CDFP interface of the CPU, and the CDFP interface of the CPU is connected to a CDFP interface of the memory bank through an I2C bus; and
the expander is configured to acquire server identification information in the computing resource pool at the CPU.

10. A Baseboard Management Controller (BMC)-based memory resource processing method, applied to a BMC-based memory resource processing device, the device comprising a BMC, memory banks, a Central Processing Unit (CPU), and Memory Expander Controller (MXC) each memory bank is correspondingly connected to each MXC and the BMC is connected to each MXC and is connected to the CPU; at least one MXC is connected to the CPU; the method comprises:
after controlling a memory resource pool where each memory bank is located and a computing resource pool where the CPU is located power-on until BIOS has been initialized, acquiring target server identification information in the computing resource pool connected to the CPU;
determining that the memory bank which corresponds to the MXC-chip connected to the CPU is a target memory bank according to the target server identification information; and
performing a power-on operation on the target memory bank to complete memory resource processing of the BMC.

11. The BMC-based memory resource processing method as claimed in claim 10, before the target server identification information in the computing resource connected to the CPU is acquired, further comprising:
acquiring a connection state between the BMC and the CPU; and
in response to that the connection state is a normal connection, determining server identification information in the computing resource pool.

12. The BMC-based memory resource processing method as claimed in claim 11, wherein the acquiring target server identification information in the computing resource pool connected to the CPU comprises:
acquiring the server identification information; and
comparing the server identification information with identification information in a pre-stored identification information table to determine the target server identification information.

13. The BMC-based memory resource processing method as claimed in claim 12, wherein the performing a power-on operation on the target memory bank comprises:
acquiring instruction information of the BMC;
sending the instruction information to each MXC, so that each MXC determines a power-on state of the memory bank to which each MXC belongs; and
in response to that it is determined that the memory bank to which each MXC belongs is the target memory bank, performing power-on processing on the target memory bank.

14. The BMC-based memory resource processing method as claimed in claim 13, wherein the instruction information of the BMC comprises at least memory asset information, temperature information, voltage information, and power consumption information.

15. The BMC-based memory resource processing method as claimed in claim 12, wherein the server identification information comprises at least server Identity Document (ID) information.

16. The BMC-based memory resource processing method as claimed in claim 10, further comprising:
in response to that other memory banks except the target memory bank are not connected to the CPU, not performing power-on processing on the other memory banks.

17. The BMC-based memory resource processing method as claimed in claim 16, further comprising:
after the target server identification information is acquired, performing resource allocation processing on the computing resource pool of the CPU.

18-19. (canceled)

20. A non-transitory computer readable storage medium, wherein a computer program is stored on the non-transitory computer readable storage medium, and the computer program, when executed by a processor, cause the processor to:
after controlling a memory resource pool where each memory bank is located and a computing resource pool where the CPU is located power-on until BIOS has been initialized, acquire target server identification information in the computing resource pool connected to the CPU;
determine that the memory bank which corresponds to the MXC connected to the CPU is a target memory bank according to the target server identification information; and
perform a power-on operation on the target memory bank to complete memory resource processing of the BMC.

21. The non-transitory computer readable storage medium as claimed in claim 20, the processor is further configured to:
acquire a connection state between the BMC and the CPU; and
in response to that the connection state is a normal connection, determine server identification information in the computing resource pool.

22. The non-transitory computer readable storage medium as claimed in claim 21, the processor is further configured to:
acquire the server identification information; and
compare the server identification information with identification information in a pre-stored identification information table to determine the target server identification information.
